(19) United States
(12) Patent Application Publication
(10) Pub. No.: US 2004/0042197 A1
(43) Pub. Date: Mar. 4, 2004

(54) Luminous strap tightener

(76) Inventor: Peter Wu, Changhua Hsien (TW)

Correspondence Address: Rabin & Berdo, P.C., Suite 500, 1101 14th Street, Washington, DC, 20005, US

(21) Appl. No.: 10/233,477

(22) Filed: Sep. 4, 2002

(51) Int. Cl. F21V 9/16

(52) U.S. Cl. 362/84

(57) ABSTRACT

A luminous strap tightener in accordance with the present invention is composed of a ratchet device (10), a seat (20), a push arm (30) and a trigger plate (40). The ratchet device (10) is mounted on the seat (20) and the push arm (30) with a handle rotatably mounted on the seat (20) and detachably engaged with the ratchet device (10). The trigger plate (40) is movably secured on the push arm (30) to control the engagement of the push arm (30) to the ratchet device (10). The handle (32) of the push arm (30) further has a luminous layer (50) formed around the handle (32) to make the strap tightener shine in a dark environment to provide a visual warning or means to mark the edges of a load.

### BACKGROUND OF THE INVENTION

1. Field of the Invention

The present invention relates to a strap tightener, and more particularly to a luminous strap tightener secured on a truck, trailer, etc., which reflects light at night to provide a visual warning and mark the edges of a load.

2. Description of Related Art

Conventional strap tightener is used with straps to tie down goods or securely fasten the goods on a transportation vehicle. Sometimes goods are stacked too high on a transportation vehicle and block warning lights and indicators from the view of drivers following the transportation vehicle. Serious accidents often occur when no warning indicators are visible to other drivers so they can maintain a safe distance from the transportation vehicle. Additionally, when goods are stored in a warehouse, finding a specific load of goods is difficult because there are no significant visual indicators on the goods.

Therefore, the present invention has arisen to mitigate and/or obviate the drawbacks of the conventional strap tightener.

### SUMMARY OF THE INVENTION

The main objective of the present invention is to provide a luminous strap tightener that has a handle and a luminous layer around the handle to make the strap tightener reflect light efficiently.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a luminous strap tightener in accordance with the present invention;

FIG. 2 is an enlarged cross-sectional side plan view of a handle of the strap tightener along line 2-2 in FIG. 1;

FIG. 3 is an operational side plan view of a flat bed truck with the strap tighteners in FIG. 1 in use on the flat bed truck; and

FIG. 4 is an enlarged cross-sectional side plan view of another embodiment of the handle of the strap tightener in accordance with the present invention.

### DETAILED DESCRIPTION OF THE INVENTION

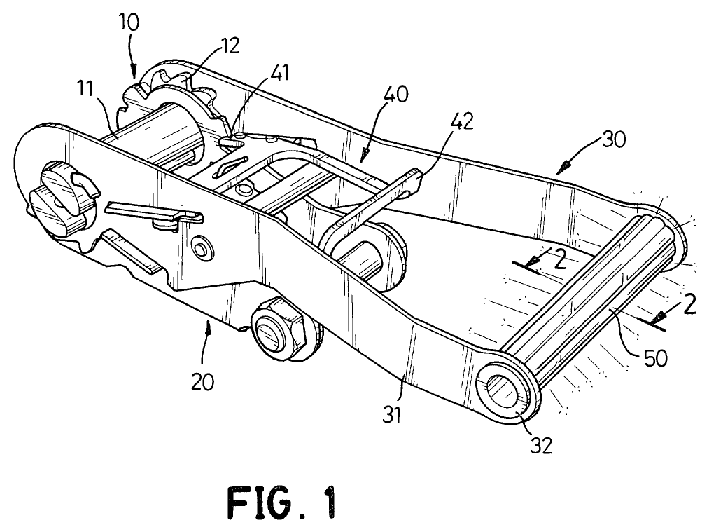

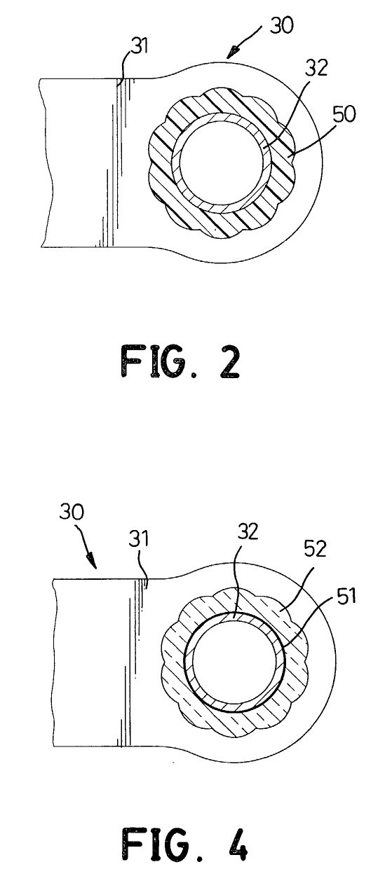

With reference to FIGS. 1 and 2, a strap tightener in accordance with the present invention comprises a seat (20), a ratchet device (10), a push arm (30) and a trigger plate (40).

The ratchet device (10) is mounted on one end of the seat (20) and has a shaft (11) and two ratchet wheels (12). The shaft (11) has two ends rotatably attached to the seat (20). The ratchet wheels (12) are respectively attached to opposite ends of the shaft (11). The push arm (30) has two side-plates (31) and a handle (32). Each side-plate (31) has two ends and one end is rotatably mounted around the shaft (11) of the ratchet device (10) to join the push arm (30) with the seat (20). The handle (32) is connected between the other ends of the two side-plates (31) of the push arm (30) for gripping the strap tightener and tightening a strap. The trigger plate (40) is pivotally and slidably mounted between the push arms (30) and has a stop end (41) detachably engaged with the ratchet wheel (12) to drive the ratchet device (10) when tightening the strap and to stop the rotation of the push arm (30). A trigger (42) is formed on a free end of the trigger plate (40) for pulling the trigger plate (40) to disengage the stop end (41) from the ratchet wheel (12) of the ratchet device (10).

The improvement of the luminous strap tightener is that the handle (32) of the push arm (30) is surrounded by a luminous layer (50). The luminous layer (50) is a plastic tube containing luminous powder and directly attached to the handle (32) by injection molding.

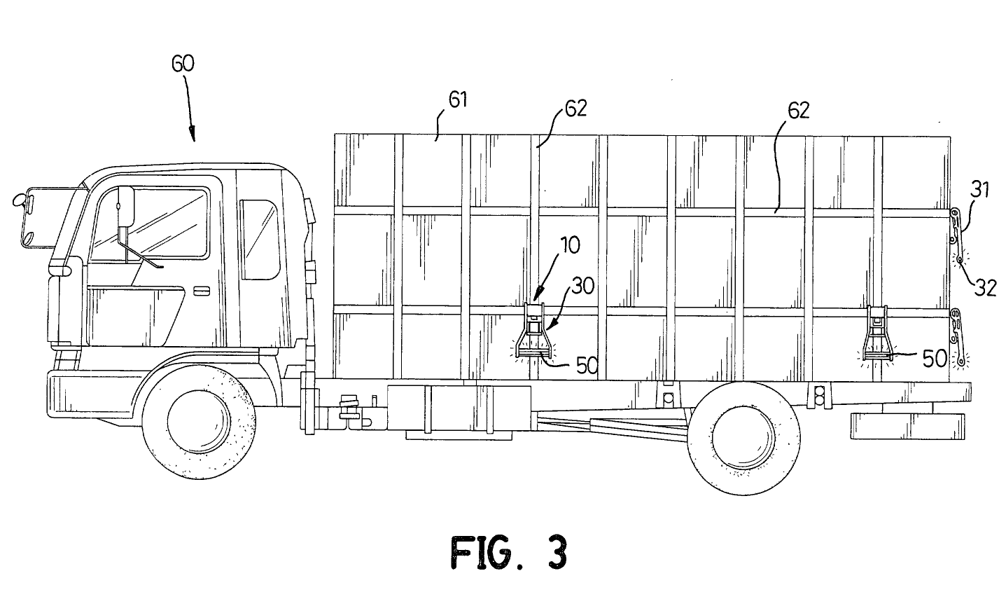

With reference to FIG. 3, the luminous strap tightener is used to securely bind a strap (62) around goods (61) and hold the goods (61) together with the straps (62) on a bed of a truck or other vehicle. The luminous layer (50) around the handle (32) reflects light to indicate a height or width of the goods, thereby providing a warning to other drivers following the truck (60) at night. Additionally, the luminous strap tightener also provides a means of marking the edges of a load for users when the goods are stored in a dark environment.

With reference to FIG. 4, another embodiment of luminous strap tightener has a luminous layer (50) composed of luminous paper (51) and a plastic tube (52). The luminous paper (51) is bonded around the handle (32) to reflect the light efficiently. The plastic tube (52) is transparent and formed on the luminous paper (51) by injection molding.

Although the invention has been explained in relation to its preferred embodiment, it is to be understood that many other possible modifications and variations can be made without departing from the spirit and scope of the invention as hereinafter claimed.

What is claimed is:

1. A luminous strap tightener in accordance with the present invention comprising:
a seat (20);
a ratchet device (10) mounted on one end of the seat (20) and having
a shaft (11) with two ends rotatably attached to the seat (20); and
two ratchet wheels (12) respectively attached to opposite ends of the shaft (11);
a push arm (30) having two side-plates (31) and a handle (32), wherein each side-plate (31) has one end rotatably mounted around the shaft (11) of the ratchet device (10) to join the push arm (30) with the seat (20); the handle (32) connected between the other end of the two side-plates (31) of the push arm (30) for gripping the strap tightener and adapting to tighten a strap; and
a trigger plate (40) pivotally and slidably mounted between the push arms (30) and having a stop end (41) detachably engaged with the ratchet wheel (12) and a trigger (42) formed on a free end of the trigger plate (40);
wherein the improvement of the luminous strap tightener comprises:
a luminous layer (50) surrounds the handle (32) of the push arm (30).

2. The luminous strap tightener as claimed in claim 1, wherein the luminous layer (50) is a plastic tube containing luminous powder.

3. The luminous strap tightener as claimed in claim 1, wherein the luminous layer (50) is composed of a luminous paper (51) bonded to the handle (32) and a transparent plastic tube (52) mounted around the luminous paper (51).
